(19) United States
(12) Patent Application Publication
(10) Pub. No.: US 2024/0154216 A1
(43) Pub. Date: May 9, 2024

(54) POUCH FILM FOR SECONDARY BATTERY WITH CONTROLLED THICKNESS PARAMETER ACCORDING TO SOLVENT DRY LAMINATION OR EXTRUSION LAMINATION AND METHOD FOR PREPARING THE SAME, SECONDARY BATTERY USING THE POUCH FILM AND METHOD FOR MANUFACTURING THE SECONDARY BATTERY

(71) Applicant: Youlchon Chemical Co., Ltd., Seoul (KR)

(72) Inventors: Nok Jung Song, Seoul (KR); Hee Sik Han, Gyeonggi-do (KR); Han Chul Park, Gyeonggi-do (KR)

(73) Assignee: Youlchon Chemical Co., Ltd., SEOUL (KR)

(21) Appl. No.: 18/386,747

(22) Filed: Nov. 3, 2023

(30) Foreign Application Priority Data
Nov. 3, 2022 (KR) 10-2022-0145588

(51) Int. Cl. H01M 50/129; H01M 50/105; H01M 50/119; H01M 50/133; H01M 50/136

(52) U.S. Cl. CPC H01M 50/129; H01M 50/105; H01M 50/119; H01M 50/133; H01M 50/136; H01M 2220/20

(57) ABSTRACT

Provided is a secondary battery pouch film, comprising an outer layer, a metal layer, and a sealant layer, wherein the sealant layer comprises a cast polypropylene (CPP) layer without an extruded polypropylene (PP) layer or comprises the cast polypropylene (CPP) layer and the extruded polypropylene (PP) layer, and the secondary battery pouch film satisfies specific equations. The pouch film has excellent formability, curling, insulation, bending, and peel strength.

### CROSS-REFERENCE TO RELATED APPLICATIONS

This application claims priority to Korean Patent Application No. 10-2022-0145588, filed on Nov. 3, 2022, and all the benefits accruing therefrom under 35 U.S.C. § 119, the contents of which in its entirety are herein incorporated by reference.

### BACKGROUND

### 1. Field

The present disclosure relates to a pouch film for a secondary battery with controlled thickness parameters according to a solvent dry lamination or an extrusion lamination and a method for preparing the same, and more particularly, relates to a pouch film for a secondary battery with controlled thickness parameters according to a solvent dry lamination or an extrusion lamination wherein the pouch film for a secondary battery has excellent peel strength, formability, insulation, bending, and curling, especially suitable for medium-sized to large-sized batteries, and a method for preparing the pouch film, a secondary battery using the pouch film and a method for manufacturing the secondary battery.

### 2. Description of the Related Art

Lithium secondary batteries (LiB) are being applied to many applications based on various advantages such as high energy density and excellent output.

As a laminated film for encasing a secondary battery, with a multi-layer structure that surrounds an electrode group and an electrolyte of the secondary battery, a secondary battery pouch film is a key component material that determines the battery's stability, lifespan characteristics, and operational sustainability and requires mechanical flexibility and strength, high oxygen/water vapor barrier properties, high thermal sealing strength, chemical resistance to electrolyte solutions, electrical insulation, and high temperature stability.

The secondary battery pouch film usually consists of an outer layer, a barrier layer, and a sealant layer inside.

The outer layer or outermost layer is made of nylon, a blend of nylon and polyethylene terephthalate (PET), oriented polypropylene (OPP), polyethylene, and the like. The outer layer or outermost layer requires heat resistance, pinhole resistance, chemical resistance, formability, and insulation etc.

The barrier layer requires formability as well as barrier properties against water vapor and other gases. In this respect, metals with formability such as aluminum (Al), iron (Fe), copper (Cu), and nickel (Ni) etc. are used in the barrier layer, and aluminum is currently used the most.

Since the sealant layer which is an inner layer is in contact with the electrolyte, it requires electrolyte resistance, and insulation resistance etc. as well as thermal adhesiveness and formability.

As the application of lithium secondary batteries (LiB) is expanded from small-sized to medium-sized to large-sized fields such as automobiles and/or energy storage systems (ESS), secondary battery pouch films also need characteristics suitable for such medium-sized to large-sized fields.

In this regard, the cell size of lithium secondary batteries (LiB) for automobiles and the forming depth of secondary battery pouches are factors that may greatly affect secondary battery capacity. The cell size thereof is larger than that of general small-sized secondary batteries and most secondary battery pouches are produced by double forming, which requires high formability. In addition, the forming depth of the secondary battery pouches determines the capacity of the cells. Thus, the deeper forming is essential to reach 700 Wh/L, which is the required capacity of next-generation secondary batteries. Accordingly, together with excellent formability, excellent properties of curling, insulation, bending, and peel strength etc. are required.

### SUMMARY

In exemplary embodiments of the present invention, in one aspect, an object is to provide a pouch film for a secondary battery having excellent properties of curling, insulation, bending, and peel strength as well as excellent formability, and a method for preparing the pouch film, a secondary battery using the pouch film and a method for manufacturing the secondary battery.

In exemplary embodiments of the present invention, a secondary battery pouch film which satisfies the following [Equation 1] is provided, the secondary battery pouch film comprising an outer layer, a metal layer, and a sealant layer, wherein the sealant layer comprises a cast polypropylene (CPP) layer without an extruded polypropylene (PP) layer.

A+B≥1.354

C=0 Equation 1

In [Equation 1], A is a value obtained by dividing a thickness of the metal layer by a total thickness of the secondary battery pouch film (i.e., thickness of metal layer/total thickness of secondary battery pouch film), B is a value obtained by dividing a thickness of the metal layer by a thickness of the sealant layer (i.e., thickness of metal layer/thickness of sealant layer), and C is a value obtained by dividing a thickness of the extruded polypropylene (PP) layer of the sealant layer by a thickness of the cast polypropylene (CPP) layer of the sealant layer (i.e., thickness of extruded PP layer/thickness of CPP layer).

In addition, in exemplary embodiments of the present invention, a secondary battery pouch film which satisfies the following [Equation 2] is provided, the secondary battery pouch film comprising an outer layer, a metal layer, and a sealant layer, wherein the sealant layer comprises a cast polypropylene (CPP) layer without an extruded polypropylene (PP) layer, or wherein the sealant layer comprises an extruded polypropylene (PP) layer and a cast polypropylene (CPP) layer.

A+B=1.354

C=1 Equation 2

In Equation 2, A is a value obtained by dividing a thickness of the metal layer by a total thickness of the secondary battery pouch film (i.e., thickness of metal layer/total thickness of secondary battery pouch film), B is a value obtained by dividing a thickness of the metal layer by a thickness of the sealant layer (i.e., thickness of metal layer/thickness of sealant layer), and C is a value obtained by dividing a thickness of the extruded polypropylene (PP) layer of the sealant layer by a thickness of the cast polypropylene (CPP) layer of the sealant layer (i.e., thickness of extruded PP layer/thickness of CPP layer).

In an exemplary embodiment, the secondary battery pouch film may have a peel strength measurement value of 8 N or more according to the method below.

Peel Strength Evaluation

A specimen is prepared by cutting the secondary battery pouch film into 15 mm width (MD) and 150 mm length (TD). After peeling off the metal layer and the sealant layer, the peel strength is measured at a speed of 50 mm/min and a degree of 90°.

In an exemplary embodiment, the secondary battery pouch film may have a curling measurement value of less than 20 mm according to the method below.

Curling Evaluation

A specimen is prepared by cutting the secondary battery pouch film into 150 mm MD and 150 mm TD. The sealant layer of the specimen is turned upward and four sides thereof are secured to a glass plate with tape, and then the specimen is cut diagonally with a knife to form an X shape in the center of the specimen. Each side of the X shape is cut to a length of 140 mm, and the height of the end of the specimen cut from the bottom to the center and curled is measured.

In an exemplary embodiment, the secondary battery pouch film may have a formability measurement value of 6 mm or more according to the method below.

Formability Evaluation

Specimens are prepared by cutting the secondary battery pouch film into 15 mm MD and 15 mm TD. The prepared specimens are formed using a secondary battery pouch forming mold (size of 3 cm×4 cm). The formability evaluation is repeated by changing the forming depth until 10 or more specimens are not broken, and the forming depth is measured when 10 or more specimens are not broken.

In an exemplary embodiment, the secondary battery pouch film may have an insulation measurement value of 100 GΩ or more, or 50 GΩ or more and less than 100 GΩ according to the method below.

Insulation Evaluation

A specimen is prepared by forming the secondary battery pouch film using a mold to have a forming depth of 6 mm or to have a maximum forming depth when the forming depth is less than 6 mm. 2 mL of electrolyte is injected into the formed specimen and a lead tab is inserted to seal all three sides. After leaving the sealed specimen at room temperature for 24 hours, a voltage of 500 V is applied to measure insulation.

In an exemplary embodiment, the secondary battery pouch film may have a bending measurement value of 50 times or more, or 30 times or more and less than 50 times, according to the method below.

Bending Evaluation

A specimen is prepared by forming the secondary battery pouch film using a mold to have a forming depth of 6 mm or to have a maximum forming depth when the forming depth is less than 6 mm. 2 mL of electrolyte is injected into the formed specimen and a lead tab is inserted to seal all three sides. After leaving the sealed specimen at room temperature for 24 hours, a voltage of 500 V is applied to select specimen with an insulation measurement value of 1 GΩ or more. Among the heat-sealed sides, the side without the lead tab is folded and unfolded repeatedly. The number of times one side is repeatedly bent is measured until the insulation measurement value becomes 1 GΩ or less.

In addition, in exemplary embodiments of the present invention, a method for manufacturing a secondary battery pouch film is provided, the secondary battery pouch film comprising an outer layer, a metal layer, and a sealant layer, wherein the sealant layer comprises a cast polypropylene (CPP) layer without an extruded polypropylene (PP) layer, or the sealant layer comprises the extruded polypropylene (PP) layer and the cast polypropylene (CPP) layer, wherein the method comprises adjusting thicknesses of layers of the secondary battery pouch film to satisfy the above-mentioned [Equation 1] or [Equation 2].

Additionally, in exemplary embodiments of the present invention, provided is a secondary battery encased with the above-described secondary battery pouch film.

In an exemplary embodiment, the secondary battery may be used for electric vehicles or energy storage devices.

Additionally, in exemplary embodiments of the present invention, provided is a method for manufacturing a secondary battery, comprising encasing the secondary battery with the above-described secondary battery pouch film.

A pouch film according to exemplary embodiments of the present invention has excellent properties of curling, peel strength, insulation and bending together with excellent formability. This secondary battery pouch film is useful for medium-sized to large-sized secondary battery, for example, of electric vehicles or energy storage devices etc.

### BRIEF DESCRIPTION OF DRAWINGS

The above and other aspects, features and advantages of the disclosed exemplary embodiments will be more apparent from the following detailed description taken in conjunction with the accompanying drawings in which:

FIG. 1 is a schematic diagram showing a configuration of a secondary battery pouch film prepared according to an SDL method.

FIG. 2 is a schematic diagram showing a configuration of a secondary battery pouch film according to an EC method.

FIG. 3 is a schematic diagram showing a shape of a specimen in a curling evaluation of an experiment.

### DETAILED DESCRIPTION

Exemplary embodiments are described more fully hereinafter. The invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the description, details of features and techniques may be omitted to more clearly disclose exemplary embodiments.

### Term Definition

In this disclosure, when a secondary battery pouch film includes layer(s), the secondary battery pouch does not necessarily consist of only that layer, and additional layers may be included therein.

In this disclosure, being formed “on” a specific layer includes not only being formed directly on that layer, but also being formed after interposing another additional layer in between.

### DESCRIPTION OF EXEMPLARY EMBODIMENTS

Exemplary embodiments of the present invention are described in detail below.

A method for preparing a sealant layer when manufacturing a secondary battery pouch film may include an extrusion lamination (hereinafter referred to as EC) and a solvent-dry lamination (hereinafter referred to as SDL).

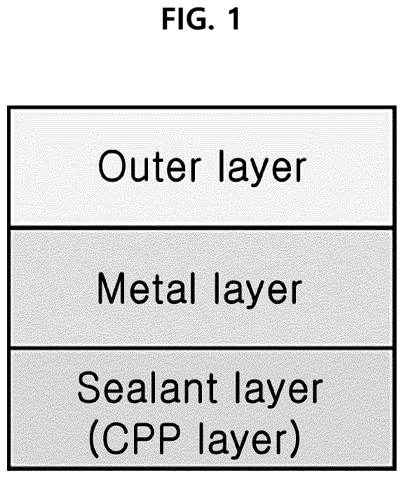

The SDL is a technique of adhering a metal layer onto a cast polypropylene (CPP) layer using a solvent-type adhesive and drying the solvent-type adhesive, and a sealant layer produced according to the aforementioned technique is composed of the cast polypropylene (CPP) layer (see FIG. 1).

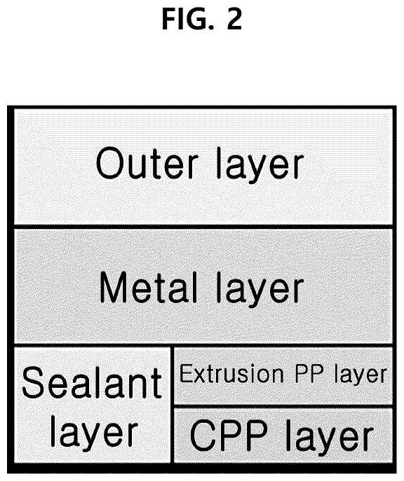

Meanwhile, the EC is a technique of extruding polypropylene resin, when adhering polypropylene, especially cast polypropylene (CPP), which is mainly used in the sealant layer, to the metal layer. As a result, the sealant layer is composed of the extruded polypropylene (PP) layer and the cast polypropylene (CPP) layer (see FIG. 2).

The present inventors conducted repeated research and arrived at the present invention after confirming that the secondary battery pouch film becomes to have the excellent peel strength, formability, insulation, bending, and further becomes to have the excellent curling, especially when using the EC in a method for preparing the secondary battery pouch film, by adjusting the thickness of the metal layer, compared to the total thickness of the pouch film and the thickness of the sealant layer, and by adjusting the thickness of the extruded polypropylene (PP) layer, among two layers consisting of the sealant layer, compared to the thickness of the cast polypropylene (CPP) layer.

The peel strength, formability, insulation, bending, and curling may be affected by a configuration and composition etc. of layer(s) of the pouch film including the sealant layer, but surprisingly, it is found that the peel strength, formability, insulation, bending and curling are able to be easily controlled by simply adjusting the thickness parameters as described above.

FIGS. 1 and 2 are schematic diagrams showing the configuration of secondary battery pouch films prepared according to the SDL method (FIG. 1) and the EC method (FIG. 2) of exemplary embodiments of the present invention.

As shown in FIG. 1, the secondary battery pouch film of an exemplary embodiment of the present invention includes an outer layer, a metal layer, and a sealant layer, wherein the sealant layer includes a cast polypropylene (CPP) layer without an extruded polypropylene (PP) layer, and may satisfy the thickness parameter of [Equation 1] below.

A+B≥1.354

C=0 Equation 1

In Equation 1, A is a value obtained by dividing a thickness of the metal layer by a total thickness of the secondary battery pouch film (i.e., thickness of metal layer/total thickness of secondary battery pouch film), B is a value obtained by dividing a thickness of the metal layer by a thickness of the sealant layer (i.e., thickness of metal layer/thickness of sealant layer), and C is a value obtained by dividing a thickness of the extruded polypropylene (PP) layer of the sealant layer by a thickness of the cast polypropylene (CPP) layer of the sealant layer (i.e., thickness of extruded PP layer/thickness of CPP layer).

When C=0, the thickness of the extruded polypropylene (PP) layer is 0 μm, that is, the sealant layer has only the cast polypropylene (CPP) layer without the extruded polypropylene (PP) layer (i.e., prepared according to the SDL method).

When the parameter of the above-mentioned [Equation 1] is satisfied, peel strength, formability, curling, insulation and bending are excellent, as can be confirmed from the experiment described below.

In an exemplary embodiment, A+B may be A+B≥1.354, A+B≥1.360, A+B≥1.365, A+B≥1.370, A+B≥1.375, A+B≥1.380, A+B≥1.385, A+B≥1390, A+B≥1.395, A+B≥1.400, A+B≥1.405, A+B≥1.410, A+B≥1.415, A+B≥1.420, A+B≥1.425, A+B≥1.430, A+B≥1.435, A+B≥1.440, A+B≥1.445, A+B≥1.450, A+B≥1.455, A+B≥1.460, A+B≥1.465, A+B≥1.470, A+B≥1.475, A+B≥1.480, A+B≥1.485, A+B≥1.490, A+B≥1.495, A+B≥1.500, A+B≥1.505, A+B≥1.510, A+B≥1.515, A+B≥1.520, A+B≥1.525, A+B≥1.530, A+B≥1.535, A+B≥1.540, A+B≥1.545, A+B≥1.550, A+B≥1.555, A+B≥1.560, A+B≥1.565, A+B≥1.570, A+B≥1.575, A+B≥1.580, A+B≥1.585, A+B≥1.590, A+B≥1.595, A+B≥1.600, A+B≥1.605, A+B≥1.610, A+B≥1.615, A+B≥1.620, A+B≥1.625, A+B≥1.630, A+B≥1.635, A+B≥1.640, A+B≥1.645, A+B≥1.650, A+B≥1.655, A+B≥1.660, A+B≥1.665, A+B≥1.670, A+B≥1.675, A+B≥1.680, A+B≥1.685, A+B≥1.690, A+B≥1.695, A+B≥1.700, A+B≥1.705, A+B≥1.710, A+B≥1.715, A+B≥1.720, A+B≥1.725, A+B≥1.730, A+B≥1.735, A+B≥1.740, A+B≥1.745, A+B≥1.750, A+B≥1.755, A+B≥1.760. In addition, A+B may be A+B≤1.763. When the thickness parameter of Equation 1 is satisfied, peel strength, formability, insulation, bending, and curling are excellent, as can be seen from the experiment described below.

As shown in FIGS. 1 and 2, the secondary battery pouch film of another exemplary embodiment of the present invention includes an outer layer, a metal layer, and a sealant layer, wherein the sealant layer includes the cast polypropylene (CPP) layer without the extruded polypropylene (PP) layer (FIG. 1) or includes the extruded polypropylene (PP) layer and the cast polypropylene (CPP) layer (FIG. 2), and may satisfy the thickness parameter of [Equation 2] below.

A+B=1.354

C=1 Equation 2

In Equation 2, A is a value obtained by dividing a thickness of the metal layer by a total thickness of the secondary battery pouch film (i.e., thickness of metal layer/total thickness of secondary battery pouch film), B is a value obtained by dividing a thickness of the metal layer by a thickness of the sealant layer (i.e., thickness of metal layer/thickness of sealant layer), and C is a value obtained by dividing a thickness of the extruded polypropylene (PP) layer of the sealant layer by a thickness of the cast polypropylene (CPP) layer of the sealant layer (i.e., thickness of extruded PP layer/thickness of CPP layer).

When C=1, the thickness of the extruded polypropylene (PP) layer is the same as that of the cast polypropylene (CPP) layer (i.e., prepared according to the EC method).

When the thickness parameter of [Equation 2] is satisfied, peel strength, formability, insulation, bending, and curling are excellent, as can be seen from the experiment described below.

In an exemplary embodiment, the outer layer may be composed of nylon, polyethylene terephthalate (PET), polybutylene terephthalate (PBT), or a mixed layer of nylon and PET, etc.

In an exemplary embodiment, the metal layer may be made of a metal such as aluminum, SUS, or copper, etc., and may have moisture permeability and impact resistance.

In an exemplary embodiment, the cast polypropylene (CPP) layer of the sealant layer may contain various additives (rubber, elastomer, slip agent, etc.) depending on the required physical properties.

In an exemplary embodiment, the total thickness of the secondary battery pouch film may be, for example, 60 μm to 185 μm. In an example, the total thickness of the secondary battery pouch film may be 153 μm or more or 113 μm or less.

In an exemplary embodiment, the thickness of the metal layer may be, for example, 20 μm to 80 μm.

In an exemplary embodiment, the thickness of the sealant layer may be, for example, 20 μm to 80 μm.

In an exemplary embodiment, the thickness of the cast polypropylene (CPP) layer of the sealant layer may be, for example, 20 μm to 80 μm.

In an exemplary embodiment, the thickness of the extruded polypropylene (PP) layer of the sealant layer may be, for example, 0 to 60 μm.

In an exemplary embodiment, the secondary battery pouch film has a peel strength measurement value of 8 N or more, according to the Experiment method described below.

In an exemplary embodiment, the secondary battery pouch film has a curling measurement value of less than 20 mm, according to the Experiment method described below.

In an exemplary embodiment, the secondary battery pouch film has a formability measurement value of 6 mm or more, according to the Experiment method described below.

In an exemplary embodiment, the secondary battery pouch film may have an insulation measurement value of 100 GΩ or more, or 50 GΩ or more and less than 100 GQ, according to the Experiment method described below.

In an exemplary embodiment, the secondary battery pouch film may have a bending measurement value of 50 times or more, or 30 times or more and less than 50 times, according to the Experiment method described below.

A method for preparing a secondary battery pouch film of exemplary embodiments of the present invention may include adjusting thicknesses of layers of the secondary battery pouch film to satisfy the above-mentioned [Equation 1] or [Equation 2], the secondary battery pouch film including an outer layer, a metal layer, and a sealant layer, wherein the sealant layer includes a cast polypropylene (CPP) layer without an extruded polypropylene (PP) layer or includes the cast polypropylene (CPP) layer and the extruded polypropylene (PP) layer.

Exemplary embodiments of the present invention may provide a secondary battery encased with the above-described secondary battery pouch film. The secondary battery may typically be a lithium secondary battery, and in particular, may be a medium-sized to large-sized secondary battery for such as electric vehicles (EV) or energy storage systems (ESS) etc.

Additionally, in exemplary embodiments of the present invention, provided is a manufacturing method of a secondary battery, the method including encasing the secondary battery with the above-described secondary battery pouch film.

Exemplary embodiments of the present invention are explained in more detail through the following examples. The embodiments disclosed herein are illustrated for illustrative purposes only, and the embodiments of the present invention may be implemented in various forms and should not be construed as limited to the embodiments described herein.

### Experiment Method

In examples and comparative examples, the outer layer is composed of a mixed layer of nylon and PET, and the metal layer is made of aluminum foil, and a thickness ratio of each layer is adjusted as shown in the tables below.

In addition, peel strength, formability, insulation, curling, and bending are evaluated using the methods described below.

Peel Strength Evaluation

Specimens are prepared by cutting the secondary battery pouch film manufactured in examples and comparative examples into 15 mm width (MD) and 150 mm length (TD). After peeling off the metal layer and the sealant layer, the peel strength is measured at a speed of 50 mm/min and a degree of 90°.

The peel strength measurement value must be 8 N or higher to be evaluated as good.

Curling Evaluation

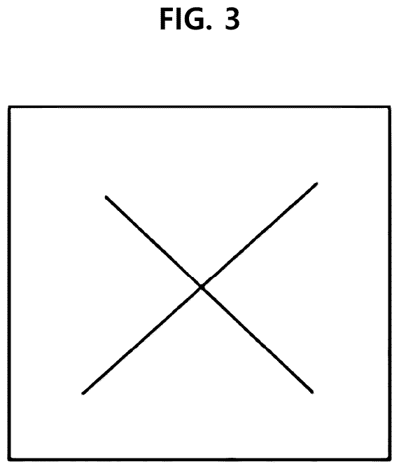

Specimens are prepared by cutting the secondary battery pouch film manufactured in examples and comparative examples into 150 mm MD and 150 mm TD. The sealant layer of the specimen is turned upward and four sides thereof are secured to a glass plate with tape, and then the specimen is cut diagonally with a knife to form an X shape in the center of the specimen. Each side of the X shape is cut to have a length of 140 mm, and the height of the end of the specimen cut from the bottom to the center and curled is measured. For reference, FIG. 3 is a schematic diagram showing the shape of the specimen.

The curling measurement value must be less than 20 mm to be evaluated as good.

Formability Evaluation

Specimens are prepared by cutting the secondary battery pouch manufactured in examples and comparative examples into 15 mm MD and 15 mm TD. The prepared specimens are formed using a mold (size of 3 cm×4 cm). The formability evaluation is repeated by changing the forming depth until 10 or more specimens are not broken. The forming depth is measured when 10 or more specimens are not broken.

The formability measurement value must be 6 mm or more to be evaluated as good.

Insulation Evaluation

Specimens are prepared by forming the secondary battery pouch film prepared in examples and comparative examples to a depth of 6 mm or to a maximum forming depth when the forming depth is less than 6 mm by using a mold (size of 3 cm×4 cm). 2 mL of electrolyte is injected into the formed specimens and a lead tab is inserted to seal all three sides. After leaving the sealed specimens at room temperature for 24 hours, a voltage of 500 V is applied to measure insulation. The evaluation results are as follows:
a: 100 GΩ or more
b: 50 GΩ or more and less than 100 GΩ
c: 25 GΩ or more and less than 50 GΩ
d: 10 GΩ or more and less than 25 GΩ
e: less than 10 GΩ

Bending Evaluation

Specimens manufactured identically to the specimens for the insulation evaluation are prepared.

That is, specimens are prepared by forming the secondary battery pouch film prepared in examples and comparative examples to a depth of 6 mm using a mold (size of 3 cm×4 cm). The secondary battery pouch film is formed at a maximum forming depth when the forming depth is 6 mm or less. 2 mL of electrolyte is injected into the formed specimens and a lead tab is inserted to seal all three sides. After leaving the sealed sample at room temperature for 24 hours, a voltage of 500 V is applied to select specimens with an insulation measurement value of 1 GΩ or more. Among the heat-sealed sides, one side without the lead tab is repeatedly folded and unfolded. The number of times one side is repeatedly bent is measured until the insulation measurement value become 1 GΩ or less. The evaluation results are as follows:
a: 50 or more times
b: 30 or more times and less than 50 times
c: 10 or more times and less than 30 times
d: 5 or more times and less than 10 times
e: less than 5 times

Evaluation Results

The tables below show the test results of thickness parameters, peel strength, formability, insulation, curling, and bending of the examples and comparative examples.

TABLE 1

| | | | | Thickness of | Sealant layer | | | |
|---|---|---|---|---|---|---|---|---|
| | | | | metal layer/ | Thickness | | | Thickness of metal |
| | | Total | | Total thickness | of | Thickness | | layer/Thickness |
| | | thickness of | Thickness of | of pouch film | Extruded | of CPP | Total thickness | of sealant layer |
| | Type | pouch film | metal layer | A | PP layer | layer | of sealant layer | B |
| Example | SDL | [symbol] | 35 | 0.39 [symbol] | 0 | 30 | 30 | 1.167 |
| 1 | | | | | | | | |
| Example | SDL | 9 [symbol] | 40 | 0.430 | 0 | 30 | 30 | 1.333 |
| 2 | | | | | | | | |
| Example | SDL | 103 | 40 | 0.388 | 0 | 30 | 30 | 1.333 |
| 3 | | | | | | | | |
| Comparative | EC | [symbol] | 35 | 0.39 [symbol] | 10 | 20 | 30 | 1.167 |
| example 1 | | | | | | | | |
| Comparative | EC | 9 [symbol] | 40 | 0.430 | 10 | 20 | 30 | 1.333 |
| example 2 | | | | | | | | |
| Comparative | EC | 103 | 40 | 0.388 | 10 | 20 | 30 | 1.333 |
| example 3 | | | | | | | | |

| | | Thickness of | | | | | |
|---|---|---|---|---|---|---|---|
| | | Extruded PP | | | | | |
| | | layer/ | | Curling | | | |
| | | Thickness of | Peel | [mm] | | | |
| | | CPP layer | strength | {Before | Formability | | |
| | A + B | C | [N] | forming) | [mm] | Insulation | Bending |
| Example | 1.564 | 0.00 | 8.5 | 4 | 6 | B | B |
| 1 | | | | | | | |
| Example | 1.763 | 0.00 | 9.1 | 2 | 6.2 | B | B |
| 2 | | | | | | | |
| Example | 1.722 | 0.00 | 9 | 3 | 6.2 | B | B |
| 3 | | | | | | | |
| Comparative | 1.564 | 0.50 | 5. [symbol] | 7 | 4.1 | C | B |
| example 1 | | | | | | | |
| Comparative | 1.763 | 0.50 | 6.1 | 5 | 4.5 | C | B |
| example 2 | | | | | | | |
| Comparative | 1.722 | 0.50 | 5. [symbol] | 5 | 4.4 | C | B |
| example 3 | | | | | | | |

[symbol]

indicates data missing or illegible when filed

As can be seen from the above experimental results, when A+B>1.354 and C=0 (manufactured by SDL method), all physical properties including peel strength, when A+B>1.354 and C is not 0 (manufactured by EC method), peel strength, insulation, and formability deteriorate (comparative examples 1, 2, and 3).

TABLE 2

| | | | | Thickness of | Sealant layer | | | |
|---|---|---|---|---|---|---|---|---|
| | | | | metal layer/ | Thickness | | | Thickness of metal |
| | | Total | | Total thickness | of | Thickness | | layer/Thickness |
| | | thickness of | Thickness of | of pouch film | Extruded | of CPP | Total thickness | of sealant layer |
| | Type | pouch film | metal layer | A | PP layer | layer | of sealant layer | B |
| Example 4 | SDL | 113 | 40 | 0.354 | 0 | 40 | 40 | 1.000 |
| Example 5 | EC | 113 | 40 | 0.354 | 20 | 20 | 40 | 1.000 |
| Comparative | EC | 113 | 40 | 0.354 | 10 | 30 | 40 | 1.000 |
| example 4 | | | | | | | | |
| Comparative | SDL | 153 | 40 | 0.261 | 0 | 80 | 80 | 0.5 |
| example | | | | | | | | |
| 5 | | | | | | | | |
| Comparative | SDL | 183 | 60 | 0.328 | 0 | 80 | 80 | 0.75 |
| example | | | | | | | | |
| 6 | | | | | | | | |

| | | Thickness of | | | | | |
|---|---|---|---|---|---|---|---|
| | | Extruded PP | | | | | |
| | | layer/ | | Curling | | | |
| | | Thickness of | Peel | [mm] | | | |
| | | CPP layer | strength | {Before | Formability | | Bending |
| | A + B | C | [N] | forming) | [mm] | Insulation | Bending |
| Example 4 | 1.354 | 0.00 | 9.5 | 3 | 6.5 | A | B |
| Example 5 | 1.354 | 1.00 | 14.1 | 8 | 6.6 | B | A |
| Comparative | 1.354 | 0.33 | 5.2 | 8 | 4.4 | B | B |
| example 4 | | | | | | | |
| Comparative | 0.761 | 0 | 5.3 | 2 | 7.2 | A | E |
| example | | | | | | | |
| 5 | | | | | | | |
| Comparative | 1.078 | 0 | 6.2 | 2 | 12.5 | A | E |
| example | | | | | | | |
| 6 | | | | | | | |

When A+B=1.354 and C=0 (manufactured by SDL method), all physical properties are generally excellent, and insulation is the most excellent compared to cases of the same thickness (example 4). In addition, when A+B=1.354 and C=1 (manufactured by EC method), all physical properties are generally excellent, and bending is the most excellent compared to cases of the same thickness (example 5). On the other hand, when A+B=1.354 and C is not 0 or when A+B=1.354 and C is not 1, the peel strength, formability, insulation, and bending deteriorate (comparative example 4).

In addition, as can be seen from comparative examples 5 and 6, the peel strength and bending deteriorate in comparative example 5 (A+B=0.761, C=0) and comparative example 6 (A+B=1.078, C=0), which are outside the case where C=0 and A+B≥1.354.

This invention relates to national research and development projects performed by Youlchon Chemical Co., Ltd. where the national research and development projects are of Material/Parts Package Type (Top Company) and named as ‘Development of a next-generation secondary battery pouch capable of realizing more than twice the high adhesive strength at 60° C.’, and periods of the projects are 2022-09-01˜2022-12-31 (assignment unique number is 1415181922, assignment number is 20022450) and 2023-01-01˜2023-12-31 (an assignment unique number is 1415185612 and an assignment number is 20022450).

Although non-limiting and exemplary embodiments of the present invention have been described above, the technical idea of the present invention is not limited to the accompanying drawings or the above description. It is obvious to those skilled in the art that various forms of modification are possible without departing from the technical spirit of the present invention, and such types of modifications will fall within the scope of the patent claims of the present invention.

What is claimed is:

1. A secondary battery pouch film comprising
an outer layer, a metal layer, and a sealant layer,
wherein the sealant layer comprises a cast polypropylene (CPP) layer that optionally contains an extruded polypropylene (PP) layer, and
the secondary battery pouch film satisfies Equation 1.

2. The secondary battery pouch film of claim 1,
wherein the secondary battery pouch film has a peel strength measurement value of 8 N or more.

3. The secondary battery pouch film of claim 1,
wherein the secondary battery pouch film has a curling measurement value of less than 20 mm.

4. The secondary battery pouch film of claim 1,
wherein the secondary battery pouch film has a formability measurement value of 6 mm or more.

5. The secondary battery pouch film of claim 1,
wherein the secondary battery pouch film has an insulation measurement value of 100 GΩ or more, or 50 GΩ or more and less than 100 GQ.

6. The secondary battery pouch film of claim 1,
wherein the secondary battery pouch film has a bending measurement value of 50 times or more, or 30 times or more and less than 50 times.

7. A manufacturing method of a secondary battery pouch film,
the secondary battery pouch film comprising an outer layer, a metal layer, and a sealant layer,
wherein the sealant layer comprises a cast polypropylene (CPP) layer without an extruded polypropylene (PP) layer,
the method comprising adjusting thicknesses of layers of the secondary battery pouch film to satisfy Equation 1.

8. A manufacturing method of a secondary battery pouch film,
the secondary battery pouch film comprising an outer layer, a metal layer, and a sealant layer,
wherein the sealant layer comprises a cast polypropylene (CPP) layer without an extruded polypropylene (PP) layer, or comprises the cast polypropylene (CPP) layer and the extruded polypropylene (PP) layer,
the method comprising adjusting thicknesses of layers of the secondary battery pouch film to satisfy Equation 2.

9. A secondary battery, characterized in that it is encased with the secondary battery pouch film of claim 1.

10. The secondary battery of claim 10,
wherein the secondary battery is for electric vehicles or energy storage devices.

11. A manufacturing method of a secondary battery, comprising
encasing the secondary battery with the secondary battery pouch film of any one of claim 1.
